(19) United States
(12) Patent Application Publication
(10) Pub. No.: US 2021/0254730 A1
(43) Pub. Date: Aug. 19, 2021

(54) INTERFLOW LIMITING VALVE ASSEMBLY

(71) Applicant: Roller Bearing Company of America, Inc., Oxford, CT (US)

(72) Inventors: Mark Alger, Oro Valley, AZ (US); David Lynde, Dayton, OH (US); Brandon Brown, Tucson, AZ (US); Jeremy Ulliman, Tucson, AZ (US)

(73) Assignee: Roller Bearing Company of America, Inc., Oxford, CT (US)

(21) Appl. No.: 17/308,546

(22) Filed: May 5, 2021

Related U.S. Application Data
(63) Continuation-in-part of application No. 16/375,258, filed on Apr. 4, 2019, now Pat. No. 11,028,928.
(60) Provisional application No. 62/653,747, filed on Apr. 6, 2018.

(51) Int. Cl. F16K 11/076; F16K 47/00

(52) U.S. Cl. CPC F16K 11/076; F16K 47/00

(57) ABSTRACT

A sleeve for a valve assembly has an annular body with an inside surface extending from a first axial sleeve-end to a second axial sleeve-end. The inside surface has a first cylindrical section and a second cylindrical section with a conical interior seating surface extending therebetween. A groove extends circumferentially around and radially outward in the first cylindrical section and axially away from the conical interior seating surface towards the first axial sleeve-end. The sleeve includes one or more first ports that extend radially through the first cylindrical section and spaced apart from the groove. The one or more first ports are spaced apart from the groove by a lip formed by the first cylindrical section. The lip extends continuously and entirely circumferentially around the first cylindrical surface and extends a predetermined axial distance between the groove and the one or more first ports.

### CROSS REFERENCE TO RELATED APPLICATIONS

The instant application is a continuation in part application of and claims priority benefit to U.S. non-provisional patent application Ser. No. 16/375,258 entitled, “Interflow Limiting Valve Assembly,” filed Apr. 4, 2019, which is a non-provisional of, and claims priority benefit to provisional patent application No. 62/653,747, entitled, “Interflow Limiting Valve Assembly,” filed Apr. 6, 2018, the entirety of which are incorporated by reference herein.

### FIELD OF THE INVENTION

The present invention relates generally to an interflow limiting valve assembly and more particularly to a sleeve having an angled metallic interior seating surface that engages an angled metallic exterior seating surface of a plug slidingly disposed in the sleeve and a radially extending lip that defines a small gap between the lip and an exterior surface of the plug to limit interflow of fluids over the lip and through the gap.

### BACKGROUND OF THE INVENTION

Valves are employed in many applications for controlling flow of fluids such as gases, liquids (e.g., hydraulic fluids), steam and slurries. The valves are of many different configurations including gate valves, throttling valves, shut off valves, check valves and relief valves. Some valves include a plurality of ports and internal components with one or more predetermined flow paths. Often, it is required to tightly shut off one or more flow paths to prevent internal or external valve leakage and undesirable interflow within the valve.

Some valve seats are soft to provide a positive and flexible sealing surface. However, soft valve seats are easily damaged and are known to leak. In addition, when controlling flow between an open and closed position, internal valve components such as valve plugs and poppets must slide easily and freely within the body of the valve. To accomplish such free movement, tightly controlled tolerances and gaps between the valve components are created. As the gaps are increased, interflow or internal leakage within the valve may occur.

During transient conditions, it is important for any valve to control the interflow timing of open/closed flow paths. Failure to properly and adequately control opening/closing of flow paths can result in undesirable pressure spikes, water-hammer effects, or unintended pressurization of separate features or components.

Thus, there is a need for an improved valve assembly that prevents interflow within the valve and provides leak tight shut-off capability.

### SUMMARY

The present invention includes a sleeve for a valve assembly. The sleeve includes an annular body that has an inside surface that extends from a first axial sleeve-end to a second axial sleeve-end of the sleeve. The inside surface defines an interior area. The inside surface has a first cylindrical section that extends axially inward from the first axial sleeve-end towards and terminating prior to the second axial sleeve-end. The inside surface has a second cylindrical section that extends axially inward from the second axial sleeve-end towards the first axial sleeve-end. A conical interior seating surface extends between the first cylindrical section and the second cylindrical section. The sleeve includes a groove that extends circumferentially around and radially outward in the first cylindrical section. The groove extends axially away from the conical interior seating surface towards the first axial sleeve-end. The sleeve includes one or more first ports that extend radially through the first cylindrical section of the inside surface and are proximate to and spaced apart from the groove. The one or more first ports are spaced apart from the groove by a lip formed by the first cylindrical section. The lip extends continuously and entirely circumferentially around the first cylindrical surface. The lip extends a predetermined axial distance between the groove and the one or more first ports.

In some embodiments, the conical interior seating surface is made of a metallic material.

In some embodiments, the sleeve includes one or more intermediately positioned ports that extend radially through the second cylindrical section of the inside surface. The lip is positioned between the one or more first ports and the one or more intermediately positioned ports.

In some embodiments, the sleeve includes one or more second ports that extend radially through the second cylindrical section of the inside surface and are located axially between the one or more intermediately positioned ports and the second axial sleeve-end.

In some embodiments, the conical interior seating surface defines a first angle (e.g., about 45 degrees) relative to a radial line oriented perpendicular to a longitudinal axis of the sleeve.

In some embodiments, the groove extends radially outward from the inside surface 0.02 inches to 0.03 inches, to provide space for forming the conical interior seating surface.

The present invention includes a valve assembly that includes a sleeve. The sleeve includes an annular body that has an inside surface that extends from a first axial sleeve-end to a second axial sleeve-end of the sleeve. The inside surface defines an interior area. The inside surface has a first cylindrical section that extends axially inward from the first axial sleeve-end towards and terminates prior to the second axial sleeve-end. The inside surface has a second cylindrical section that extends axially inward from the second axial sleeve-end towards the first axial sleeve-end. A conical interior seating surface extends between the first cylindrical section and the second cylindrical section. The sleeve has a groove that extends circumferentially around and radially outward in the first cylindrical section. The groove extends axially away from the conical interior seating surface towards the first axial sleeve-end. The sleeve includes one or more first ports that extend radially through the first cylindrical section of the inside surface and are proximate to and spaced apart from the groove. The one or more first ports are spaced apart from the groove by a lip formed by the first cylindrical section. The lip extends continuously and entirely circumferentially around the first cylindrical surface. The lip extends a predetermined axial distance between the groove and the one or more first ports. The valve assembly includes an annular plug that is disposed in the interior area of the sleeve. The plug has an exterior surface that extends from a first axial plug-end to a second axial plug-end of the plug. The exterior surface of the plug has a first plug surface section which extends axially from the first plug-end to an axial facing transition plane The exterior surface of the plug has a conical exterior seating surface that extends from the first plug surface section and tapers axially towards the second axial plug-end and tapers radially inward from the first plug surface section. A portion of the exterior surface of the plug slidingly engages a portion of the inside surface of the annular body. The plug defines a closed position wherein the conical exterior seating surface sealingly engages the conical interior seating surface. The lip is in sealing proximity to at least a portion of the exterior surface of the plug thereby forming a barrier to the axial flow of fluids across the lip.

In some embodiments, the conical interior seating surface is made from a metallic material.

In some embodiments, one or more intermediately positioned ports extend radially through the second cylindrical section of the inside surface and the lip is positioned between the one or more first ports and the one or more intermediately positioned ports.

In some embodiments, the sleeve includes one or more second ports that extend radially through the second cylindrical section of the inside surface and are located axially between the one or more intermediately positioned ports and the second axial sleeve-end.

In some embodiments, the conical interior seating surface defines a first angle (e.g., about 45 degrees) relative to a radial line oriented perpendicular to a longitudinal axis of the sleeve.

In some embodiments, the groove extends radially outward from the inside surface about 0.02 inches to about 0.03 inches, to provide space for forming the conical interior seating surface.

In some embodiments, the lip and the exterior surface of the plug are spaced apart by a gap of about 0.001 inches to about 0.0025 inches.

In some embodiments, the conical exterior seating surface defines a second angle (e.g., about 47 degrees) relative to a longitudinal axis of the plug.

In some embodiments, in a first plug position, the plug is positioned in the sleeve such that the one or more first ports are in fluid communication with the one or more intermediately positioned ports and the one or more second ports are in sealed relation with the one or more first ports and the one or more intermediately positioned ports.

In some embodiments, in a second plug position, the plug is positioned in the sleeve such that the one or more first ports, the one or more intermediately positioned ports and the one or more second ports are in sealed relation to one another.

In some embodiments, in a third plug position, the plug is positioned in the sleeve such that the one or more intermediately positioned ports and the one or more second ports are in in fluid communication with one another and are in sealed relation to the one or more first ports.

There is disclosed herein, a sleeve for a valve assembly. The sleeve includes an annular body that has an inside surface extending from a first axial sleeve-end to a second axial sleeve-end of the sleeve. The inside surface defines an interior area and has a first cylindrical section extending from the first axial sleeve-end and a second cylindrical section located between the first cylindrical section and the second axial sleeve-end. A conical interior seating surface extends between the first cylindrical section and the second cylindrical section. The conical interior seating surface is metallic. The sleeve includes a groove that extends circumferentially around and radially outward in the first cylindrical section. The groove extends axially away from the conical interior seating surface towards the first axial sleeve-end. A plurality of ports extend radially through the first cylindrical section of the inside surface proximate the groove. The plurality of ports includes one or more first ports (e.g., supply ports) that are spaced apart from the groove by a lip formed by the first cylindrical section. The lip extends a predetermined axial distance between the groove and the one or more first ports. The lip extends circumferentially around the first cylindrical section and radially inward from the first cylindrical section.

In one embodiment, the conical interior seating surface defines a first angle (e.g., 45 degrees) relative to a radial line oriented perpendicular to a longitudinal axis of the sleeve.

In one embodiment, the groove extends radially outward from the inside surface about 0.02 inches to about 0.03 inches, to provide space for forming the conical interior seating surface.

There is further disclosed herein a valve assembly that includes a sleeve and a plug therein. The sleeve includes an annular body that has an inside surface extending from a first axial sleeve-end to a second axial sleeve-end of the sleeve. The inside surface defines an interior area and the inside surface has a first cylindrical section extending from the first axial sleeve-end and a second cylindrical section located between the first axial sleeve-end and the second axial sleeve-end. A conical interior seating surface extends between the first cylindrical section and the second cylindrical section. The conical interior seating surface is metallic. The sleeve includes a groove that extends circumferentially around and radially outward in the first cylindrical section. The groove extends axially away from the conical interior seating surface towards the first axial sleeve-end. A plurality of ports extend radially through the first cylindrical section of the inside surface proximate the groove. The plurality of ports includes one or more first ports (e.g., supply ports). The one or more first ports are spaced apart from the groove by a lip formed by the first cylindrical section. The lip extends a predetermined axial distance between the groove and the one or more first ports. The lip extends circumferentially around the first cylindrical section and radially inward from the first cylindrical section. The valve assembly includes an annular plug disposed in the interior area of the sleeve. The plug has an exterior surface that extends from a first axial plug-end to a second axial plug-end of the plug. The conical exterior seating surface extends axially inward from the second axial plug-end of the plug. The conical exterior seating surface is metallic. A portion of the exterior surface of the plug slidingly engages a portion of the inside surface of the annular body. The plug defines a closed position wherein the conical exterior seating surface sealingly engages the conical interior seating surface. The lip is in sealing proximity to a portion of the exterior surface of the plug, thereby forming a barrier to the axial flow of fluids across the lip.

In one embodiment, the conical interior seating surface defines a first angle (e.g., about 45 degrees) relative to a radial line oriented perpendicular to a longitudinal axis of the sleeve.

In one embodiment, the groove extends radially outward from the inside surface about 0.02 inches to about 0.03 inches, to provide space for forming the conical interior seating surface.

In one embodiment, the lip and the exterior surface of the plug are spaced apart by a gap of about 0.001 inches to about 0.0025 inches.

In one embodiment, the conical exterior seating surface defines a second angle (e.g., about 47 degrees) relative to a longitudinal axis of the plug.

In one embodiment, the plurality of ports further includes one or more second ports (e.g., return ports).

In one embodiment, during axial transition of the plug relative to the sleeve the exterior surface of the plug slidingly engages with the interior surface of the sleeve to cover the one or more first ports.

In one embodiment, when the exterior surface of the plug covers the one or more first ports, a portion of the one or more second ports is covered by the exterior surface of the plug.

### DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A is a front view of the valve assembly of the present invention;

FIG. 1B is a cross sectional view of the valve assembly of FIG. 1A, taken across section 1B-1B;

FIG. 1C is a cross sectional view of the valve assembly of FIG. 1A, taken across section 1C-1C;

FIG. 2 is a cross sectional view of the valve assembly of FIG. 1A, taken across section 2-2;

FIG. 3 is a cross sectional view of a sleeve portion of the valve assembly of FIG. 1A, taken across section 2-2;

FIG. 4 is an enlarged view of detail 4 of the sleeve illustrated in FIG. 3;

FIG. 5 is a front view of the plug of the present invention;

FIG. 6 is an enlarged view of detail 6 of a portion of the plug illustrated in FIG. 5; and

FIG. 7A is an enlarged view of detail 7 in the valve assembly of FIG. 2 with the plug uncovering a first port, covering a second port and creating a flow path between the first port and a third port located between the first port and the second port;

FIG. 7B is an enlarged view of detail 7 in the valve assembly of FIG. 2 with the plug covering the first port and second port thereby blocking flow between the first, second and third ports; and

FIG. 7C is an enlarged view of detail 7 in the valve assembly of FIG. 2 with the plug covering the first port and partially uncovering the second port and creating a flow path between the third port and the second port.

### DETAILED DESCRIPTION

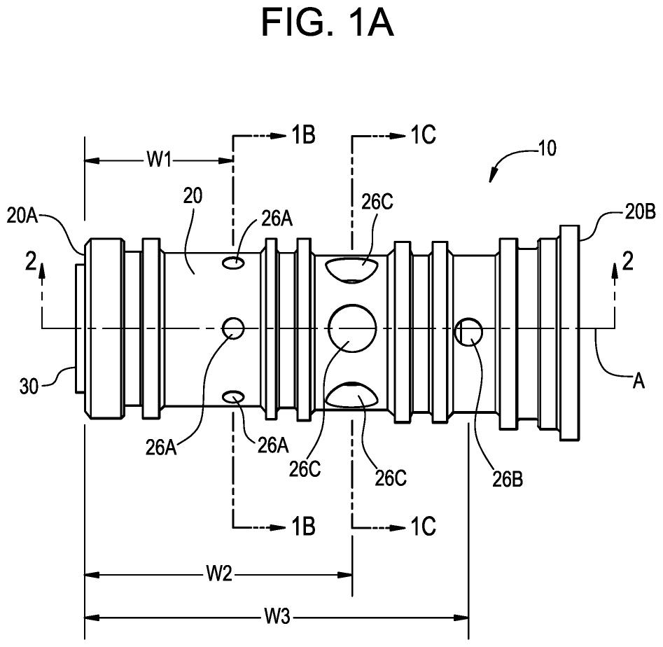

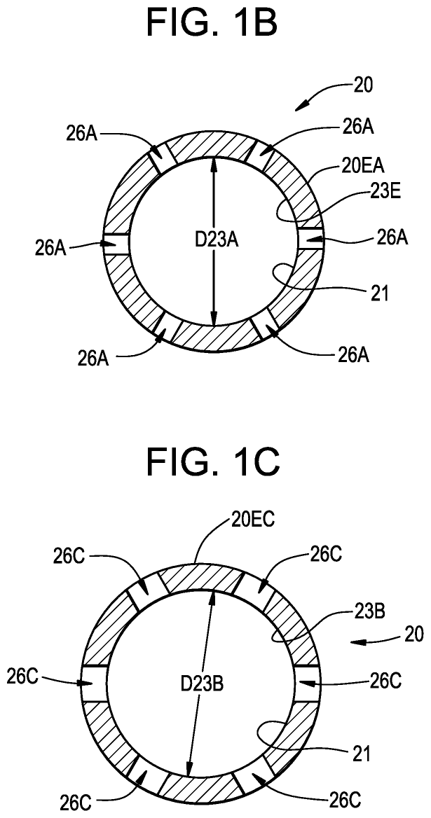

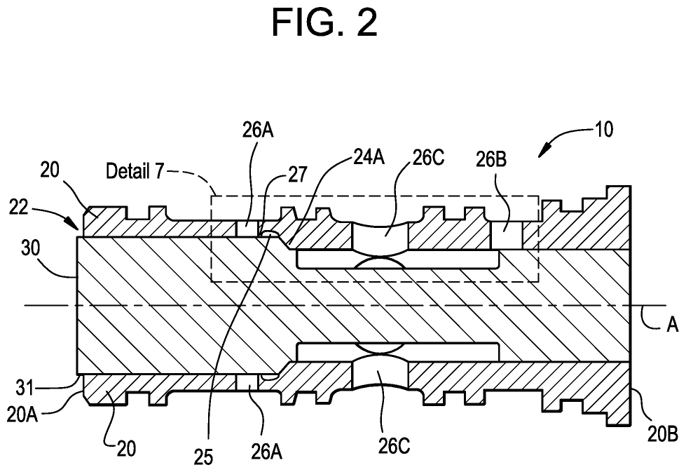

As shown in FIGS. 1A and 2, a valve assembly of the present invention is generally designated by the numeral 10. The valve assembly 10 includes a sleeve 20 (e.g., annular body) and a plug 30 disposed in an interior area 22 (see FIG. 2) of the sleeve 20. The plug 30 is configured to slide in the interior of the sleeve 20 to control the flow of fluid through the valve assembly 10.

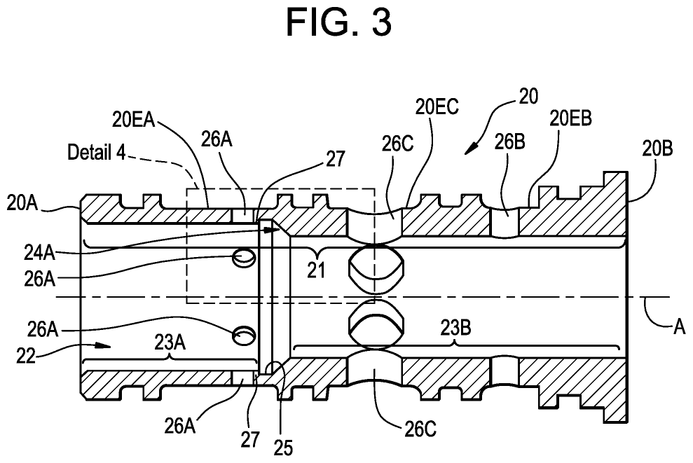

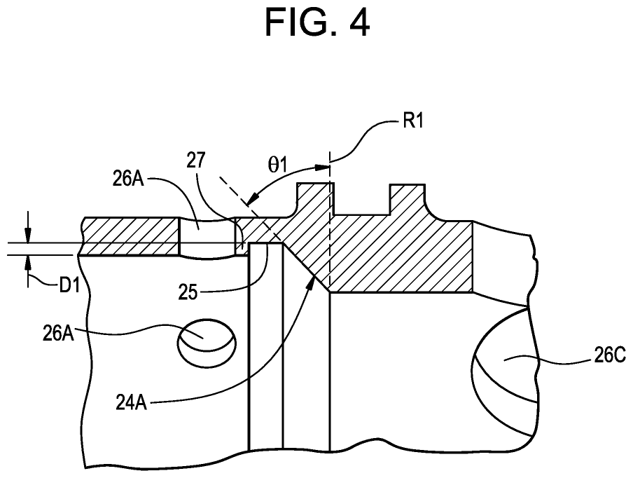

As shown in FIG. 3, the sleeve 20 is configured as an annular body that has an inside surface 21 that extends from a first axial sleeve-end 20A to a second axial sleeve-end 20B of the sleeve 20. The inside surface 21 defines the interior area 22. The inside surface 21 has a first cylindrical section 23A that extends axially inward from the first axial sleeve-end 20A towards and terminating prior to the second axial sleeve-end 20B. The first cylindrical section 23A has a first sleeve inside diameter D23A along the entire axial length thereof, as shown in FIG. 1B. The inside surface 21 has a second cylindrical section 23B that extends axially inward from the second axial sleeve-end 20B towards and terminating prior to the first axial sleeve-end 20A. The second cylindrical section 23B has a second sleeve inside diameter D23B along the entire axial length thereof, as shown in FIG. 1C. The sleeve 20 includes a first conical interior seating surface 24A that extends between the first cylindrical section 23A and the second cylindrical section 23B. As shown in FIGS. 3 and 4, a first conical seating surface 24A defines a first angle θ1 relative to a radial line R1 oriented perpendicular to a longitudinal axis A of the sleeve 20. In one embodiment, the first angle θ1 is about 45 degrees (+/−1°).

The first conical interior seating surface 24A is made from a metallic material such as an austenitic or ferritic stainless steel or a copper based alloy such as a bronze. In one embodiment, the entire sleeve 20 is manufactured from a metallic material such as an austenitic or ferritic stainless steel or a copper based alloy such as a bronze.

As shown in FIGS. 3-4, the sleeve 20 includes a groove 25 that extends circumferentially entirely and continuously around and radially outward into the first cylindrical section 23A. The groove 25 extends axially away from the first conical interior seating surface 24A towards the first axial sleeve-end 20A. In one embodiment, the groove 25 extends radially outward from the first cylindrical section 23A of the inside surface 21 a radial distance D1 of about 0.02 inches to about 0.03 inches, to provide space for forming (e.g., machining) the first conical interior seating surface 24A, as shown in FIG. 4.

As shown collectively in FIGS. 1A-4, the sleeve 20 includes a plurality of ports that extend radially through the sleeve 20. As best shown in FIGS. 1A, 1B and 3, the plurality of ports includes six first ports 26A (e.g., a “supply ports”) each of which extend radially through the first cylindrical section 23A of the inside surface 21 proximate the groove 25 and through an exterior surface 20EA of the sleeve. The six first ports 26A are spaced apart from the groove 25 by a lip 27 as detailed further herein. The six first ports 26A are located between the first axial sleeve-end 20A of the sleeve 20 and the lip 27. The six first ports 26A are shown circumferentially spaced apart from one another in circumferential symmetry and are axially aligned with one another. Reference to “supply ports” is not meant to be restrictive to the flow of fluids, as it is contemplated that any port can provide a supply and/or a return of fluids. While six first ports 26A are shown and described, the present invention is not limited in this regard as other configurations of the sleeve 20 are included in the present invention including but not limited to at least one first port 26A and more or less than six first ports 26A. While the six first ports 26A are shown and described as being circumferentially spaced apart from one another in circumferential symmetry and axially aligned with one another, the present invention is not limited in this regard as the present invention includes other configurations including but not limited to the first ports being spaced apart from one another in circumferential asymmetry and/or axially offset from one another.

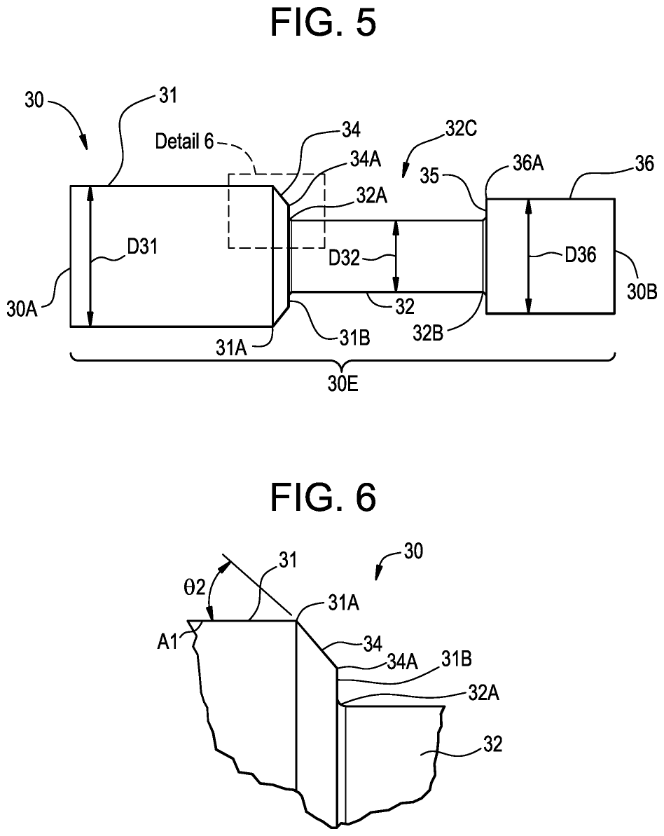

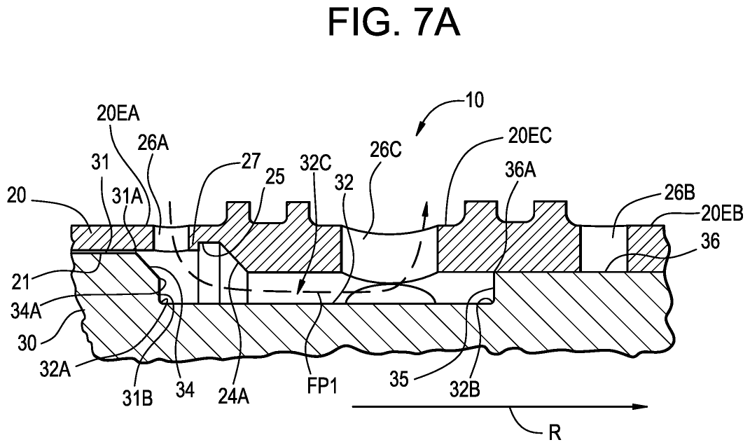

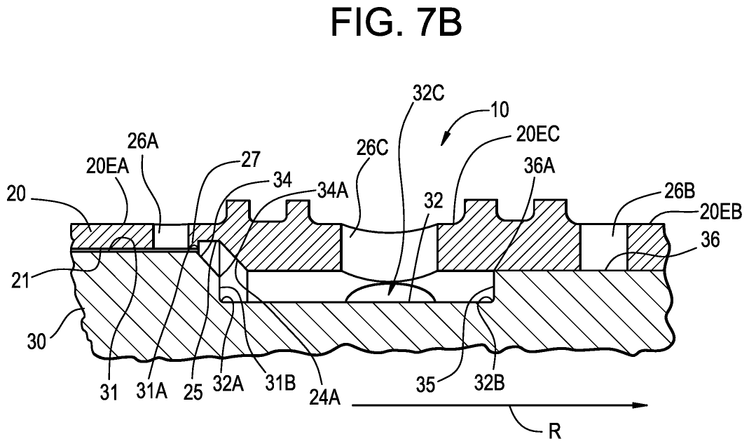

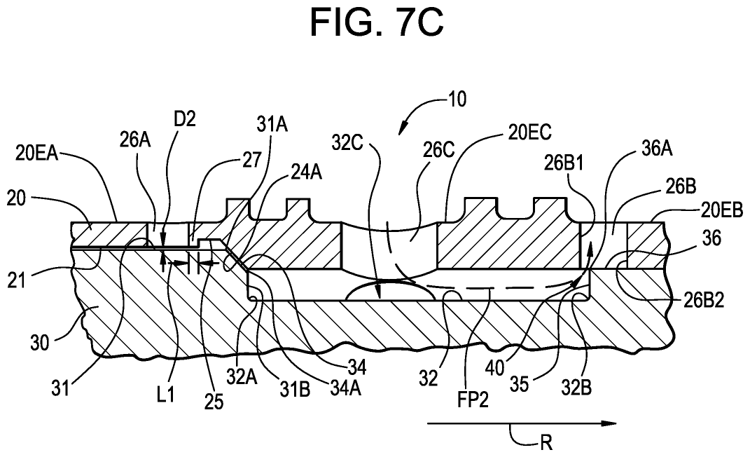

The first ports 26A are spaced apart from the groove 25 by the lip 27 formed by the first cylindrical section 23A of the inside surface 21. As best shown in FIG. 7C, the lip 27 extends axially a predetermined axial distance L1 of about 0.010 inches to about 0.050 inches between the groove 25 and the first ports 26A. The lip 27 extends continuously and entirely circumferentially around (i.e., circumferentially uninterrupted) the first cylindrical surface 23A. The lip 27 has the first sleeve inside diameter D23A of the first cylindrical section 23A. As shown in FIG. 7C, the lip 27 and a first plug surface section 31 of the exterior surface 30E of the plug 30 are spaced apart from one another by a gap D2 of about 0.001 inches to about 0.0025 inches. The first plug surface section 31 has a first outside plug diameter D31, as shown in FIG. 5. The gap D2 is calculated by subtracting the first outside plug diameter D31 from the first sleeve inside diameter D23A and dividing the difference by two. The gap D2 defines an annular space between the first plug surface section 31 and the lip 27. The gap D2 is configured to prevent or limit the flow of fluids (e.g., hydraulic fluids) over the lip 27 and through the gap D2.

As shown in FIGS. 1A and 3, the plurality of ports also includes a second port 26B (e.g., a “return port”) that extends radially through the second cylindrical section 23B of the inside surface 21, through the sleeve 20 and through an exterior surface 20EB of the sleeve 20. Reference to “return ports” is not meant to be restrictive to the flow of fluids, as it is contemplated that any port can provide a supply and/or a return of fluids. While one second port 26B is shown and described, the present invention is not limited in this regard as other configurations are included in the invention including more than one second port 26B.

As best shown in FIGS. 1A, 1C and 3, the sleeve 20 includes six intermediately positioned ports 26C located axially between the first ports 26A and the second port 26B. Each of the intermediately positioned ports 26C extend radially through the second cylindrical section 23B of the inside surface 21, through the sleeve 20 and through an exterior surface 20EC of the sleeve 20. The six intermediately positioned ports 26C are shown circumferentially spaced apart from one another in circumferential symmetry and are axially aligned with one another. The intermediately positioned ports 26C are axially spaced apart from the groove 25 and the lip 27. The intermediately positioned ports 26C are spaced apart from the first ports 26A and the second port 26B. While six intermediately positioned ports 26C are shown and described, the present invention is not limited in this regard as other configurations of the sleeve 20 are included in the present invention including but not limited to at least one intermediately positioned port 26C and more or less than six intermediately positioned ports 26C. While the six intermediately positioned ports 26C are shown and described as being circumferentially spaced apart from one another in circumferential symmetry and axially aligned with one another, the present invention is not limited in this regard as the present invention includes other configurations including but not limited to the intermediately positioned ports being spaced apart from one another in circumferential asymmetry and/or axially offset from one another.

In the embodiment shown in FIGS. 7A-7C, the second port 26B is shown axially to the right of the first ports 26A in the downstream direction of the arrow R. For example, the second port 26B is axially downstream of the first port 26A. As shown in FIG. 2, the annular plug 30 is disposed in the interior area 22 of the sleeve 20.

As shown in FIG. 5, the plug 30 has an exterior surface 30E that extends from a first axial plug-end 30A to a second axial plug-end 30B of the plug 30. The exterior surface 30E of the plug 30 has a stepped configuration. The exterior surface 30E of the plug 30 includes the first plug surface section 31 which extends axially from the first plug-end 30A to an axial facing transition plane 31A. The first plug surface section 31 is cylindrical. A conical exterior seating surface 34 extends from the first plug surface section 31 and tapers axially towards the second axial plug-end 30B and radially inward from the first plug surface section 31 of the plug 30. The conical exterior seating surface 34 terminates at a first radially outermost circumferential edge 34A of a first axial shoulder 31B. The first axial shoulder 31B faces towards the second axial plug-end 30B.

As shown in FIG. 5, the exterior surface 30E of the plug 30 has a second plug surface section 32 that extends axially from a first radially innermost portion 32A of the first axial shoulder 31B towards the second axial plug-end 30B and terminates at a second radially innermost portion 32B of a second axial shoulder 35. The second plug surface section 32 is cylindrical. The second axially shoulder 35 faces towards the first axial shoulder 31B. The second axial shoulder 35 terminates at a radially outermost edge 36A thereof.

As shown in FIG. 5, the exterior surface 30E of the plug 30 has a third plug surface section 36 that extends axially from the radially outermost edge 36A of the second axially shoulder 35 towards and terminating at the second axial plug-end 30B. The third plug surface section 36 is cylindrical. The first plug surface section 31 has the first outside plug diameter D31. The second plug surface section 32 has a second outside plug diameter D32. The third plug surface section 36 has a third outside plug diameter D36. The first outside plug diameter D31 is greater than the second outside plug diameter D32 and is greater than the third outside plug diameter D36. The second outside plug diameter D32 is less than the first plug outside diameter D31 and is less than the third outside plug diameter D36. The third outside plug diameter D36 is greater than the second outside plug diameter D32 and is less than the first outside plug diameter D31. An annular channel 32C is defined between the first axial shoulder 31B and the second axial shoulder 35 and along the second plug surface section 32.

As shown in FIG. 6, the conical exterior seating surface 34 defines an angle θ2 relative to a reference line A1 that is parallel to the longitudinal axis A. In one embodiment, the angle θ2 is about 47 degrees, +/−1°. The conical exterior seating surface 34 is made from a metallic material such as an austenitic or ferritic stainless steel or a copper based alloy such as a bronze. In one embodiment, the entire plug 30 is manufactured from a metallic material such as an austenitic or ferritic stainless steel or a copper based alloy such as a bronze.

As shown in FIGS. 2 and 7A-7C, a portion of the exterior surface 30E of the plug 30 slidingly engages (e.g., in an axial direction indicated by the arrow R) a portion of the inside surface 21 of the annular body 20.

As shown in FIG. 7A, the third plug surface section 36 of the exterior surface 30E of the plug 30 fully covers the second port 26B of the sleeve 20 while leaving the first ports 26A uncovered. As shown in FIG. 7A, this creates a flow path from the first ports 26A to the third ports 26C. In the configuration illustrated in FIG. 7A, the first ports 26A are in fluid communication (i.e., via flow path FP1) with the annular channel 32C and the intermediately positioned ports 26C. In the configuration illustrated in FIG. 7A, the second port 26B is in sealed relation with the first ports 26A, the annular channel 32C and the intermediately positioned ports 26C.

FIG. 7B illustrates a position of the plug 30 after it has moved farther axially downstream in direction R compared to the position shown in FIG. 7A. The conical exterior surface 34 has moved downstream of the first ports 26A, thereby causing the first plug surface section 31 of the exterior surface 30E of the plug 30 to fully cover the first ports 26A. In FIG. 7B, while the first ports 26A are fully covered, the third plug surface section 36 of the exterior surface 30E of the plug 30 fully covers the second port 26B The position of the plug 30 in FIG. 7B cuts off the supply flow of fluid between the first ports 26A and the second port 26B. In the configuration shown in FIG. 7B, the first ports 26A, the intermediately positioned ports 26C and the second port 26B are in sealed relation to one another.

As shown best in FIG. 7C, the plug 30 defines a closed position in which a supply flow from the first ports 26A into the sleeve 20 is blocked by sealing engagement of the conical exterior seating surface 34 with the first conical interior seating surface 24A and the lip 27 is in sealing proximity to the first plug surface section 31 of the exterior surface 30E of the plug 30 thereby forming a barrier to the axial flow of fluids from the supply flow across the lip 27. As shown in FIG. 7C, the second port 26B has an upstream edge 26B1 and a downstream edge 26B2, wherein the upstream to downstream direction is indicated by the arrow R. As shown in FIG. 7C, the second axial shoulder 35 is positioned downstream of the upstream edge 26B1 of the second port 26B thereby creating an opening 40 between the annular channel 32C and the second port 26B. In the closed position illustrated in FIG. 7C, the intermediately positioned ports 26C are in fluid communication (i.e., via flow path FP2) with the second port 26B. In the closed position illustrated in FIG. 7C, the first ports 26A are in sealed relation to the annular channel 32C and the second port 26B.

Although the present invention has been disclosed and described with reference to certain embodiments thereof, it should be noted that other variations and modifications may be made, and it is intended that the following claims cover the variations and modifications within the true scope of the invention.

What is claimed is:

1. A sleeve for a valve assembly, the sleeve comprising:
an annular body having an inside surface extending from a first axial sleeve-end to a second axial sleeve-end of the sleeve, the inside surface defining an interior area, the inside surface having a first cylindrical section extending axially inward from the first axial sleeve-end towards and terminating prior to the second axial sleeve-end, the inside surface having a second cylindrical section extending axially inward from the second axial sleeve-end towards the first axial sleeve-end, a conical interior seating surface extending between the first cylindrical section and the second cylindrical section;
a groove extending circumferentially around and radially outward in the first cylindrical section, the groove extending axially away from the conical interior seating surface towards the first axial sleeve-end; and
at least one first port extending radially through the first cylindrical section of the inside surface proximate to and spaced apart from the groove, the at least one first port being spaced apart from the groove by a lip formed by the first cylindrical section, the lip extending continuously and entirely circumferentially around the first cylindrical surface and the lip extending a predetermined axial distance between the groove and the at least one first port.

2. The sleeve of claim 1, wherein the conical interior seating surface comprises a metallic material.

3. The sleeve of claim 1, further comprising at least one intermediately positioned port extending radially through the second cylindrical section of the inside surface, wherein the lip is positioned between the at least one first port and the at least one intermediately positioned port.

4. The sleeve of claim 3, further comprising at least one second port extending radially through the second cylindrical section of the inside surface and located axially between the at least one intermediately positioned port and the second axial sleeve-end.

5. The sleeve of claim 1, wherein the conical interior seating surface defines a first angle relative to a radial line oriented perpendicular to a longitudinal axis of the sleeve.

6. The sleeve of claim 5, wherein the first angle is about 45 degrees.

7. The sleeve of claim 1, wherein the groove extends radially outward from the inside surface 0.02 inches to 0.03 inches, to provide space for forming the conical interior seating surface.

8. A valve assembly comprising:
a sleeve comprising:
an annular body having an inside surface extending from a first axial sleeve-end to a second axial sleeve-end of the sleeve, the inside surface defining an interior area, the inside surface having a first cylindrical section extending axially inward from the first axial sleeve-end towards and terminating prior to the second axial sleeve-end, the inside surface having a second cylindrical section extending axially inward from the second axial sleeve-end towards the first axial sleeve-end, a conical interior seating surface extending between the first cylindrical section and the second cylindrical section;
a groove extending circumferentially around and radially outward in the first cylindrical section, the groove extending axially away from the conical interior seating surface towards the first axial sleeve-end; and
at least one first port extending radially through the first cylindrical section of the inside surface proximate to and spaced apart from the groove, the at least one first port being spaced apart from the groove by a lip formed by the first cylindrical section, the lip extending continuously and entirely circumferentially around the first cylindrical surface and the lip extending a predetermined axial distance between the groove and the at least one first port;
an annular plug disposed in the interior area of the sleeve, the plug comprising an exterior surface extending from a first axial plug-end to a second axial plug-end of the plug, the exterior surface of the plug having a first plug surface section which extends axially from the first plug-end to an axial facing transition plane, a conical exterior seating surface extending from the first plug surface section and tapering axially towards the second axial plug-end and tapering radially inward from the first plug surface section;
at least a portion of the exterior surface of the plug slidingly engaging at least a portion of the inside surface of the annular body, and the plug defining a closed position wherein the conical exterior seating surface sealingly engages the conical interior seating surface; and
the lip being in sealing proximity to at least a portion of the exterior surface of the plug thereby forming a barrier to the axial flow of fluids across the lip.

9. The valve assembly of claim 8, wherein the conical interior seating surface comprises a metallic material.

10. The valve assembly of claim 8, further comprising at least one intermediately positioned port extending radially through the second cylindrical section of the inside surface, wherein the lip is positioned between the at least one first port and the at least one intermediately positioned port.

11. The valve assembly of claim 10, further comprising at least one second port extending radially through the second cylindrical section of the inside surface and located axially between the at least one intermediately positioned port and the second axial sleeve-end.

12. The valve assembly of claim 8, wherein the conical interior seating surface defines a first angle relative to a radial line oriented perpendicular to a longitudinal axis of the sleeve.

13. The valve assembly of claim 12, wherein the first angle is about 45 degrees.

14. The valve assembly of claim 8, wherein the groove extends radially outward from the inside surface about 0.02 inches to about 0.03 inches, to provide space for forming the conical interior seating surface.

15. The valve assembly of claim 8, wherein the lip and the exterior surface of the plug are spaced apart by a gap of about 0.001 inches to about 0.0025 inches.

16. The valve assembly of claim 8, wherein the conical exterior seating surface defines a second angle relative to a longitudinal axis of the plug.

17. The valve assembly of claim 16, wherein the second angle is about 47 degrees.

18. The valve assembly of claim 11, wherein in a first plug position, the plug is positioned in the sleeve such that the at least one first port is in fluid communication with the at least one intermediately positioned port and the at least one second port is in sealed relation with the at least one first port and the at least one intermediately positioned port.

19. The valve assembly of claim 11, wherein in a second plug position, the plug is positioned in the sleeve such that the at least one first port, the at least one intermediately positioned port and the at least one second port are in sealed relation to one another.

20. The valve assembly of claim 11, wherein in a third plug position, the plug is positioned in the sleeve such that the at least one intermediately positioned port and the at least one second port are in in fluid communication with one another and are in sealed relation to the at least one first port.

21. A sleeve for a valve assembly, the sleeve comprising:
an annular body having an inside surface extending from a first axial sleeve-end to a second axial sleeve-end of the sleeve, the inside surface defining an interior area, the inside surface having a first cylindrical section extending from the first axial sleeve-end and a second cylindrical section located between the first cylindrical section and the second axial sleeve-end, a conical interior seating surface extending between the first cylindrical section and the second cylindrical section, the conical interior seating surface being metallic;
a groove extending circumferentially around and radially outward in the first cylindrical section, the groove extending axially away from the conical interior seating surface towards the first axial sleeve-end; and
at least one first port extending radially through the first cylindrical section of the inside surface proximate the groove, the at least one first port being spaced apart from the groove by a lip formed by the first cylindrical section, the lip extending a predetermined axial distance between the groove and the at least one first port, and the lip extending circumferentially around the first cylindrical section and extending radially inward from the first cylindrical section.

22. The sleeve of claim 21, wherein the conical interior seating surface defines a first angle relative to a radial line oriented perpendicular to a longitudinal axis of the sleeve.

23. The sleeve of claim 22, wherein the first angle is about 45 degrees.

24. The sleeve of claim 21, wherein the groove extends radially outward from the inside surface about 0.02 inches to about 0.03 inches, to provide space for forming the conical interior seating surface.

25. A valve assembly comprising:
a sleeve comprising:
an annular body having an inside surface extending from a first axial sleeve-end to a second axial sleeve-end of the sleeve, the inside surface defining an interior area, the inside surface having a first cylindrical section extending from the first axial sleeve-end and a second cylindrical section located between the first cylindrical section and the second axial sleeve-end, a conical interior seating surface extending between the first cylindrical section and the second cylindrical section, the conical interior seating surface being metallic;
a groove extending circumferentially around and radially outward in the first cylindrical section, the groove extending axially away from the conical interior seating surface towards the first axial sleeve-end; and
at least one first port extending radially through the first cylindrical section of the inside surface proximate the groove, the at least one first port being spaced apart from the groove by a lip formed by the first cylindrical section, the lip extending a predetermined axial distance between the groove and the at least one first port, and the lip extending circumferentially around the first cylindrical section and extending radially inward from the first cylindrical section;
an annular plug disposed in the interior area of the sleeve, the plug comprising an exterior surface extending from a first axial plug-end to a second axial plug-end of the plug, a conical exterior seating surface extending axially inward from the second axial plug-end of the plug, the conical exterior seating surface being metallic;
at least a portion of the exterior surface of the plug slidingly engaging at least a portion of the inside surface of the annular body, and the plug defining a closed position wherein the conical exterior seating surface sealingly engages the conical interior seating surface; and
the lip being in sealing proximity to at least a portion of the exterior surface of the plug thereby forming a barrier to the axial flow of fluids across the lip.

26. The valve assembly of claim 25, wherein the conical interior seating surface defines a first angle relative to a radial line oriented perpendicular to a longitudinal axis of the sleeve.

27. The valve assembly of claim 26, wherein the first angle is about 45 degrees.

28. The valve assembly of claim 25, wherein the groove extends radially outward from the inside surface about 0.02 inches to about 0.03 inches, to provide space for forming the conical interior seating surface.

29. The valve assembly of claim 25, wherein the lip and the exterior surface of the plug are spaced apart by a gap of about 0.001 inches to about 0.0025 inches.

30. The valve assembly of claim 25, wherein the conical exterior seating surface defines a second angle relative to a longitudinal axis of the plug.

31. The valve assembly of claim 30, wherein the second angle is about 47 degrees.

32. The valve assembly of claim 25, wherein the sleeve further comprises at least one second port.

33. The valve assembly of claim 32, wherein during axial transition of the plug relative to the sleeve the exterior surface of the plug slidingly engages with the interior surface of the sleeve to cover the at least one first port.

34. The valve assembly of claim 33, wherein when the exterior surface of the plug covers the at least one first port, at least a portion of the at least one second port is covered by the exterior surface of the plug.
